(19) United States
(12) Patent Application Publication
(10) Pub. No.: US 2009/0256900 A1
(43) Pub. Date: Oct. 15, 2009

(54) System and Method for Optical Printing on a Laser Printer

(75) Inventor: Teong Yu Julius Lim, Gardens (SG)

Correspondence Address: BAKER BOTTS L.L.P., One Shell Plaza, 910 Louisiana, Houston, TX, 77002-4995, US

(73) Assignee: DELL PRODUCTS L.P.

(21) Appl. No.: 12/101,548

(22) Filed: Apr. 11, 2008

(51) Int. Cl. B41J 2/47

(52) U.S. Cl. 347/239

(57) ABSTRACT

A laser printer includes a light source that is passed through or conditioned by an LCD (Liquid Crystal Display) apparatus, a DLP (Digital Light mirrors) apparatus, to filter the light source before the light beam is applied to the photosensitive drum for the purpose of dispensing toner to paper. Passing the light beam through an LCD apparatus or a DLP apparatus results in the light intensity of each dot of the printed page being controlled by the LCD apparatus or the DLP apparatus. After the light beam is passed through an LCD apparatus or a DLP apparatus, the conditioned light is applied to a photosensitive drum, causing the drum to be charged in a manner to transfer toner to the printed page.

### TECHNICAL FIELD

The present disclosure relates generally to laser printers, and, more particularly, to a system and method for optical printing on a laser printer.

### BACKGROUND

The parameter dots per inch (dpi) is a measure of printing resolution and describes the number of discrete dots of inch within one linear inch. With respect to laser printing, although a printed image with a higher dot per inch measure results in an image of greater resolution, printing with higher dots per inch measure often results in a slower print speed, which is undesirable. In a laser printer, the size of each dot of toner can be adjusted by modulating the power of the laser. Color gradations are achieved by varying the intensity of each dot. Although a smaller dot size is useful for higher resolution outputs, a smaller dot size limits the ability of the printer to control the color saturation and contrast of the printed page. For high speed laser printer, the mechanical elements of the laser printer, including the raster mirror and the drum, have to operate at a very high speed. These mechanical elements are powered by electric motors. Because the motors must operate at a correspondingly high speed, the motors can be noisy and distracting in an office environment. As a result, the resolution of a laser printer is often limited by a desire for a laser printer that prints with a desirable print speed and with a minimum of noise and wear on the mechanical elements of the printer.

### SUMMARY

In accordance with the present disclosure, a laser printer includes a light source that is passed through or conditioned by an LCD (Liquid Crystal Display) apparatus, a DLP (Digital Light mirrors) apparatus, to filter the light source before the light beam is applied to the photosensitive drum for the purpose of dispensing toner to paper. Passing the light beam through an LCD apparatus or a DLP apparatus results in the light intensity of each dot of the printed page being controlled by the LCD apparatus or the DLP apparatus. After the light beam is passed through an LCD apparatus or a DLP apparatus, the conditioned light is applied to a photosensitive drum, causing the drum to be charged in a manner to transfer toner to the printed page.

The laser printer system described herein is technically advantageous. Because the pixel control characteristics of the LCD apparatus or the DLP apparatus are used to control the intensity of each dot on the printed page, the effective pixel count and the corresponding print quality of the printed page can be increased. The laser printer system is also technically advantageous because the intensity of the light source is not varied as part of the printing process. As a result, the thermal stress experienced by the light source is reduced, extending the usable life span of the light source. The laser printer system is also technically advantageous because the use of an LCD apparatus or a DLP apparatus for filtering the light before application to the photosensitive drum removes the need for a rotating raster mirror in the laser printer. The lack of a rotating raster mirror in the disclosed laser printer allows the printer to operate at a higher print speed at an acceptable noise level, while maintaining the improved print quality afforded with the use of an LCD apparatus or the DLP apparatus as the light filter for the photosensitive drum. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is an exploded view of the passage of light through a laser printer 10 that includes an LCD apparatus as a light screen;

FIG. 2 is an exploded view of the passage of light through a laser printer 10 that includes a DLP mirror as a light screen;

FIG. 3 is an exploded view of a source array of LEDs and a lens array;

FIG. 4 is a diagram of a light beam that has been segmented into pixels;

FIG. 5 is a diagram of a light beam that has been segmented into pixels in which each pixel is subdivided into two subpixels; and

FIG. 6 is a diagram of a light beam that has been segmented into pixels in which each pixel is subdivided into four subpixels.

### DETAILED DESCRIPTION

The present disclosure is directed to a laser printer in which the light beam is passed through or conditioned by an LCD (liquid crystal display) apparatus or a DLP (digital light mirror) apparatus to filter the light source before the light source is applied to the photosensitive drum for the purpose of dispensing toner to paper. Passing the light beam through an LCD apparatus or a DLP apparatus results in the light intensity of each dot of the printed page being controlled by the LCD apparatus or the DLP apparatus. Thus, the pixel control characteristics of the LCD apparatus or the DLP apparatus are used to control the intensity of each dot on the printed page, thereby increasing the effective pixel count and the corresponding print quality of the printed page. Because the intensity of the light source is not varied as part of the printing process, the thermal stress experienced by the light source is reduced, extending the usable life span of the light source. The use of an LCD apparatus or a DLP apparatus for filtering the light before application to the photosensitive drum removes the need for a rotating raster mirror in the laser printer. The lack of a rotating raster mirror in the disclosed laser printer allows the printer to operate at a higher print speed at an acceptable noise level, while maintaining the improved print quality afforded with the use of an LCD apparatus or the DLP apparatus as the light filter for the photosensitive drum.

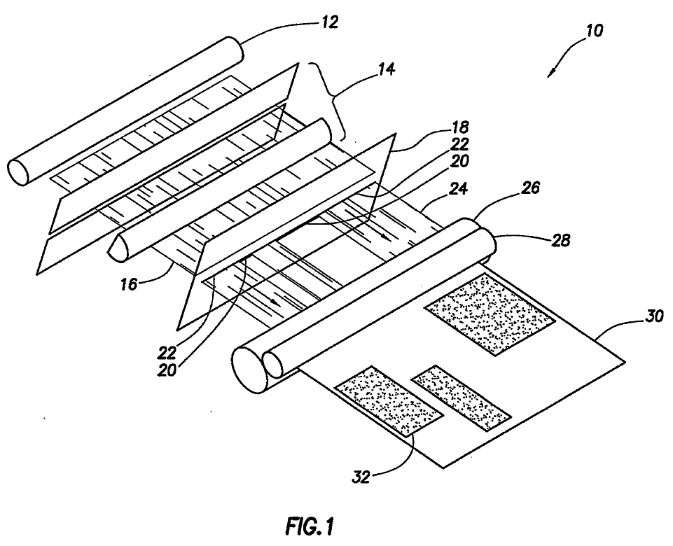

Shown in FIG. 1 is an exploded view of the passage of light through a laser printer 10 that includes an LCD apparatus as a light screen. Light is emitted from light source 12 and pass through an optical conditioner unit 14, which provides a collimated light source 16. Collimated light beam 16 is provided to LCD screen 18. LCD screen 18 comprises a set of LCD shutters which are arranged in a row and that receive the collimated light source 16. As shown in FIG. 1, the shutters are opened, closed, or partly opened to pass all or some portion of the collimated light source. The dimensions of each shutter will be smaller than that of the diameter of the light beam. In the example of FIG. 1, shutters 20 are closed and no light passes therethrough. Shutters 22 are open, allowing at least some light 24 to pass through the shutters. The light that is passed through the LCD screen reaches the photosensitive drum 26. The application of light to the photosensitive drum results in application of toner to the printed page in the areas of the printed page that correspond to the areas of the drum that receive light that passed through the LCD screen. The brighter the light 24, the more toner that is transferred from toner roller 28 to printed page 30.

In the laser printer of FIG. 1, a raster mirror is not required. Instead, the shutters of LCD screen 18 are opened and closed according to a raster image provided through an image processor and image buffer (not shown). Instead of the moving a laser across the drum, the light source is applied by the LCD screen in a way that causes the drum to pick up toner from the toner roller. Because a raster mirror is not involved in the printing process, the laser printer can operate at a high print speed without sacrificing the print quality or sound level of the laser printer.

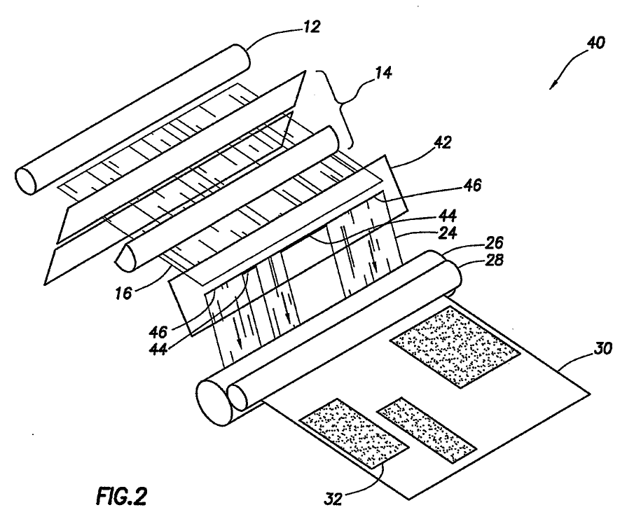

Shown in FIG. 2 is an exploded view of the passage of light through a laser printer 10 that includes a DLP mirror as a light screen. Like the laser printer of FIG. 1, the laser printer of FIG. 2 includes a light source 12 that passes light through an optical conditioner unit 14 that provides as an output a collimated light source 16. The collimated light beam 16 is applied to a DLP mirror 42. DLP mirror 42 includes a number of mirror segments that are turned off (shown at 44) and a number of segments that turned on (shown at 46). The mirror segments that are turned off block light. The mirror segments that are turned on (made fully reflective) reflects some or the entire collimated light beam, as indicated at 24. The light 24 that are reflected on the mirror segments of DLP mirror 42 reaches the photosensitive drum 26, resulting in a the application of toner being applied to the printed page in the areas of the printed page that correspond to the areas of the drum that receive light.

Like the laser printer of FIG. 1, the brighter the light 24 that is applied to the drum, the more toner that will be transferred from toner roller 28 to printed page 30. As shown in FIG. 2, the location 32 of the toner on the printed page 30 corresponds to the location of the reflective segments 22 in DLP mirror 42. Like the laser printer of FIG. 1, a raster mirror is not required. Instead, reflective segments of the DLP mirror are turned on and off to reflect light on the DLP mirror in selected locations to cause the photosensitive drum to pick up toner. The lack of a raster mirror allows the printer to operate at a high print speed, without sacrificing print quality or the sound level of the laser printer.

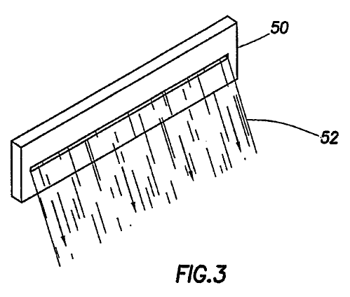

Shown in FIG. 3 is an exploded view of a source array of LEDs 50 and a lens array 52. The use of an array of LEDs and lens array 52 produces a parallel or collimated light beams. Lens array 52 is a set of light pipes 52, with each pipe being a lens, produces a parallel or collimated light beams. A singular pipe or lens conducts light for a pixel. Lens array 52 applies parallel from the light source to pass light beams on to an LCD apparatus or a DLP apparatus. The light from LED array 50 and lens array 52 can be used as a light source in place of the light source 12 and optical conditioner 14 of the LCD-based printer of FIG. 1 or in place of the light source 12 and optical conditioner 14 of the DLP-based printer of FIG. 2. The lens array 52 is passed to an LCD filter (shown in FIG. 1 at 18) or a DLP mirror (shown in FIG. 2 at 42), before the application of light to the photosensitive drum. A printer operating according to this embodiment would function just as the printers shown in FIGS. 1 and 2, with the exception that the light source would come from the LEDs 50 and lens array 52, and not the light source 12 and optical conditioner 14 of FIGS. 1 and 2. Like the embodiments of FIG. 1 and FIG. 2, the placement of an LED array and lens array in a printer reduces or eliminates the need for a raster mirror in laser printer.

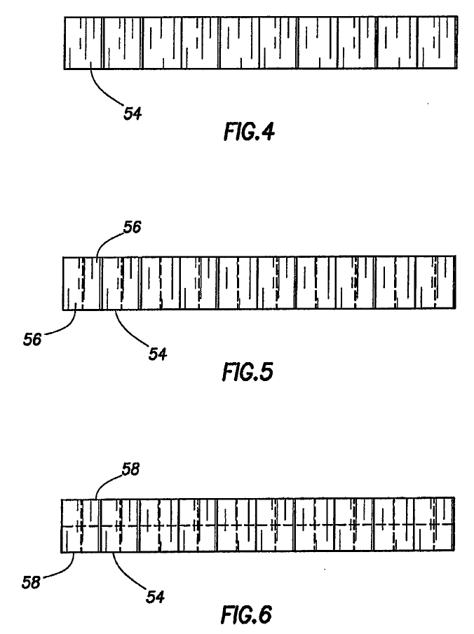

The printing system disclosed herein provides a technique for transforming a parallel light source into a number of discrete light elements or pixels. Once the light source has been reduced to a number of discrete light elements or pixels, the application of an LCD shutter or DLP mirror can further subdivide the light elements or pixels into sub-pixels, thereby increasing the granularity of the printing image. As a result, the light arriving at the photosensitive drum is pixelated. Shown in FIG. 4 is a diagram of a light beam that has been segmented into pixels 54. In FIG. 5, each of the pixels 54 is further subdivided into two subpixels 56. In the example of FIG. 6, each pixel 54 is subdivided into four subpixels 58. Creating subpixels from a single pixel increases the granularity of the image. In addition, because each group of subpixels is printed at once, the printing of the subpixels is accomplished as a swath of subpixels, resulting in a printing system that is faster as compared to the granularity of the printed image. Further, using an LED as a light source, and increasing the granularity of the image with a lens array increases the durability of the printer. The image is modified by the LCD shutter or DLP mirror, and not by varying the intensity of the light from the LED. Because the intensity of the LED source is not varied, the LED light source is more durable.

Although the present disclosure has been described in detail, it should be understood that various changes, substitutions, and alterations can be made hereto without departing from the spirit and the scope of the invention as defined by the appended claims.

What is claimed is:

1. A laser printer, comprising:
a light source;
an LCD light screen, wherein the light from the light source is passed through the LCD light screen; and
a photosensitive drum receiving the light following the passage of the light through the LCD light screen, wherein the application of light to the drum causes the drum to be charged in a manner that transfers toner to a paper page.

2. The laser printer of claim 1, wherein an optical conditioner is placed in the path of light between the light source and the LCD light screen.

3. The laser printer of claim 2, wherein the light traveling between the optical conditioner and the LCD light screen is collimated light.

4. The laser printer of claim 1, wherein the LCD light screen includes shutters that are operable to open and close to regulate the light that is passed to the photosensitive drum.

5. The laser printer of claim 1, wherein the laser printer does not include a raster for directing light to the photosensitive drum.

6. The laser printer of claim 1, wherein the light traveling between the LCD light screen and the photosensitive drum is pixelated.

7. The laser printer of claim 6, wherein the pixels of light traveling between the LCD light screen and the photosensitive drum is divided into subpixels.

8. A laser printer, comprising:
a light source;
an DLP mirror light screen, wherein the light from the light source is reflected on the DLP mirror; and
a photosensitive drum receiving the light following the passage of the reflected light from the DLP mirror, wherein the application of light to the drum causes the drum to be charged in a manner that transfers toner to a paper page.

9. The laser printer of claim 8, wherein an optical conditioner is placed in the path of light between the light source and the DLP mirror.

10. The laser printer of claim 9, wherein the light traveling between the optical conditioner and the DLP mirror light screen is collimated light.

11. The laser printer of claim 8, wherein the DLP mirror light screen includes mirrors that are operable to regulate the light by controlling reflectivity levels, that is passed to the photosensitive drum.

12. The laser printer of claim 8, wherein the laser printer does not include a raster for directing light to the photosensitive drum.

13. The laser printer of claim 8, wherein the light traveling between the DLP mirror light screen and the photosensitive drum is pixelated.

14. The laser printer of claim 13, wherein the pixels of light traveling between the LCD light screen and the photosensitive drum is divided into subpixels.

15. A laser printer, comprising:
an LED array;
a lens array, wherein the light from the light source is passed through the lens array; and
a photosensitive drum receiving the light passed through the lens array, wherein the application of light to the drum causes the drum to be charged in a manner that transfers toner to a paper page.

15. The laser printer of claim 14, wherein the light traveling between the LED array and within the lens array is collimated light.

16. The laser printer of claim 15, wherein the lens array is operable to conduct light.

17. The laser printer of claim 15, wherein the laser printer does not include a raster for directing light to the photosensitive drum.

18. The laser printer of claim 8, wherein the light traveling between the lens array and the photosensitive drum is pixelated.

19. The laser printer of claim 18, wherein the pixels of light traveling between the LCD light screen and the photosensitive drum is divided into subpixels.

20. The laser printer of claim 19, wherein subpixels comprise at least two subpixels.
